(19) United States
(12) Patent Application Publication
(10) Pub. No.: US 2024/0202529 A1
(43) Pub. Date: Jun. 20, 2024

(54) EFFICIENT MACHINE LEARNING MODEL ARCHITECTURES FOR TRAINING AND INFERENCE

(71) Applicant: QUALCOMM Incorporated, San Diego, CA (US)

(72) Inventors: Joseph Binamira SORIAGA, San Diego, CA (US); Hossein HOSSEINI, San Diego, CA (US)

(21) Appl. No.: 18/068,987

(22) Filed: Dec. 20, 2022

(51) Int. Cl. G06N 3/084

(52) U.S. Cl. CPC G06N 3/084

(57) ABSTRACT

Certain aspects of the present disclosure provide techniques for improved machine learning. A data tensor is generated as output from a layer of a neural network. A first subset of the first data tensor and a second subset of the first data tensor are generated using a tensor splitting operation. The second subset of the first data tensor is stored, and the first subset of the first data tensor is provided to a subsequent layer of the neural network. One or more parameters of the layer of the neural network are refined based at least in part on the stored second subset of the first data tensor.

### INTRODUCTION

Aspects of the present disclosure relate to machine learning.

Machine learning architectures have been used to provide solutions for a wide variety of computational problems. The training process for common machine learning models typically uses significant computational resources, such as memory space, which are often not available in common deployment systems (e.g., on an end-user's smartphone). For example, to train a neural network model using conventional approaches, the activations for each layer (computed during the forward pass) are generally stored (e.g., maintained in memory) in order to compute the gradients during backpropagation. In common network architectures, the memory footprint of these activations can be substantial, causing training to be difficult or impossible on memory-constrained devices.

Some invertible model architectures have been developed, where each layer's activations can be reconstructed during backpropagation. While this invertible architecture reduces the memory footprint of the training process (e.g., because less data is stored during the forward pass), the architecture also substantially increases the model size (e.g., in number of parameters), which can similarly increase the computational expense and latency of both training and inference with the models.

### BRIEF SUMMARY

Certain aspects provide a processor-implemented method, comprising: generating a first data tensor as output from a first layer of a neural network; generating a first subset of the first data tensor and a second subset of the first data tensor using a tensor splitting operation; storing the second subset of the first data tensor; providing the first subset of the first data tensor to a subsequent layer of the neural network; an refining one or more parameters of the first layer of the neural network based at least in part on the stored second subset of the first data tensor.

Certain aspects also provide an additional processor-implemented method, comprising: accessing, at a layer of a neural network, a first input data tensor and a second input data tensor; generating, using the layer of the neural network, a first output data tensor and a second output data tensor by processing the first input data tensor and the second input data tensor, wherein: the first output data tensor is equal to the first input data tensor; the second output data tensor is generated by: applying one or more convolution operations to the first input data tensor; applying a multiplication operation to generate the second output data tensor; and the first and second input data tensors can be reconstructed based on the first and second output data tensors; and outputting the first and second output data tensors from the layer of the neural network.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIGS. 1A and 1B depict example workflows for efficient invertible machine learning model training.

FIG. 2 depicts an example architecture for efficient invertible machine learning model training.

FIG. 3 depicts an example workflow for tensor splitting to provide efficient invertible machine learning.

FIG. 4 depicts an example architecture for an efficient invertible machine learning model block.

FIG. 5 is a flow diagram depicting an example method for efficient invertible machine learning model training during a forward pass.

FIG. 6 is a flow diagram depicting an example method for efficient invertible machine learning model training during a backward pass.

FIG. 7 is a flow diagram depicting an example method for efficient machine learning.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for improved invertible machine learning model architectures and training.

In some aspects, a tensor splitting operation (also referred to as activation splitting in some aspects) is used at various points in a machine learning model architecture in order to reduce the memory footprint of the training process, while maintaining a small model size and high inference accuracy.

In at least one aspect, after one or more invertible layers of a deep neural network model, the tensor splitting operation is applied in order to reduce the tensor size of the data that is provided to the subsequent layer. That is, a first subset of the output tensor from a given layer (e.g., half of the output tensor) may be provided as input to the subsequent layer, while another subset (e.g., the other half of the output tensor) may be stored (e.g., in memory) to be used in backpropagation. In some aspects, this (reduced) stored tensor size provides a significantly reduced memory footprint of the training process, as a smaller number of activations (or other data elements) are stored. Further, because a smaller tensor size is used as input for the subsequent layer, the subsequent layer generally requires fewer parameters (as compared to conventional architectures), thereby reducing model size substantially. In some aspects, if the presently disclosed invertible architecture with tensor splitting is used after each layer of a network, the total memory requirement (across all layers) may be equal to the size that is required to train a single layer in conventional model architectures.

In an aspect, during backpropagation, one portion of the tensor can be recreated (e.g., because the layer is invertible), while the other portion can be retrieved from storage or memory. In this way, the original tensor can be recreated and used to refine the model efficiently (e.g., with a reduced model size and reduced memory footprint, as compared to conventional approaches).

Advantageously, the invertible architectures and techniques described herein enable training of deep neural networks and other models on memory-limited devices, while still maintaining the model size (e.g., as compared to conventional invertible approaches that substantially increase model size) and accuracy.

### Example Workflows for Efficient Invertible Machine Learning Model Training

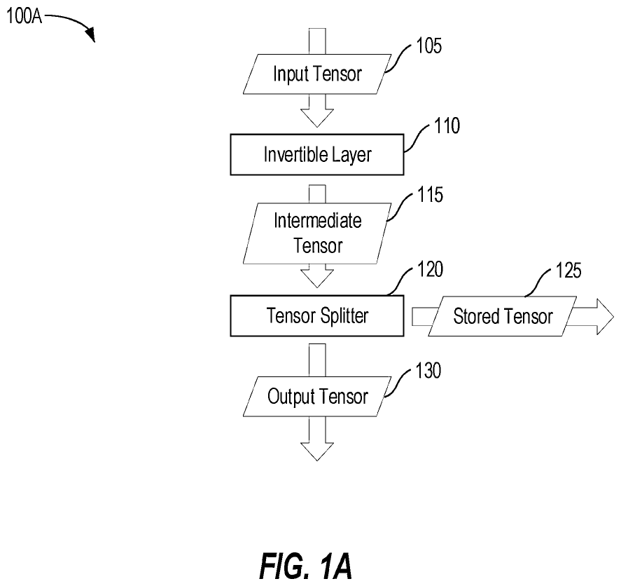

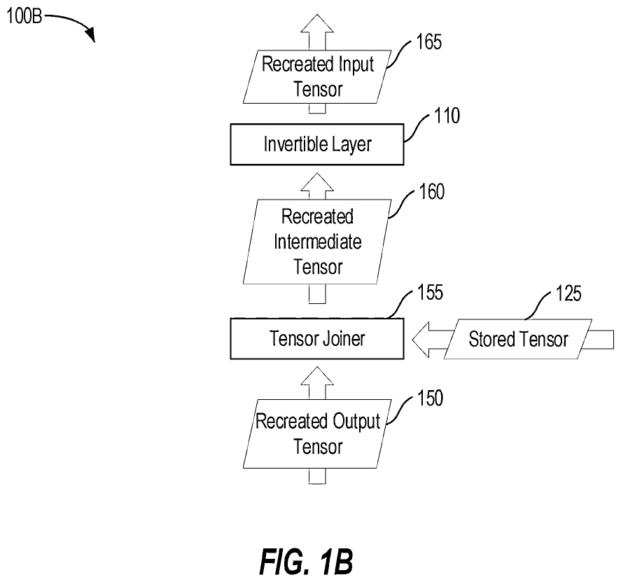

FIGS. 1A and 1B depict example workflows for efficient invertible machine learning model training. Specifically, FIG. 1A depicts a workflow 100A for processing data during a forward pass through a machine learning model (where the invertible layer 110 is one layer of the model), such as while input data is processed to generate an output inference, while FIG. 1B depicts a workflow 100B for processing data during a backward pass through the machine learning model (e.g., during backpropagation where model parameters are refined based on a label associated with the original input data). In at least one aspect, the workflows 100A and 100B are performed by a computing system, such as a machine learning system, that performs training of machine learning models.

As illustrated in FIG. 1A, an input tensor 105 is accessed or received as input to an invertible layer 110. In an aspect, the invertible layer 110 may correspond to a layer of a neural network (e.g., a deep neural network) machine learning model. The input tensor 105 may correspond to a tensor that was generated by a prior layer in the neural network, or may correspond to original input data (e.g., where the invertible layer 110 is the first layer in the network).

Generally, the invertible layer 110 may include or specify a set of parameters (e.g., a set of weights) that are used to generate output data based on input data. For example, the input tensor 105 may be multiplied with weights specified for the invertible layer 110, or the input tensor 105 may be convolved with kernels (e.g., sets of learned weights) specified for the invertible layer 110.

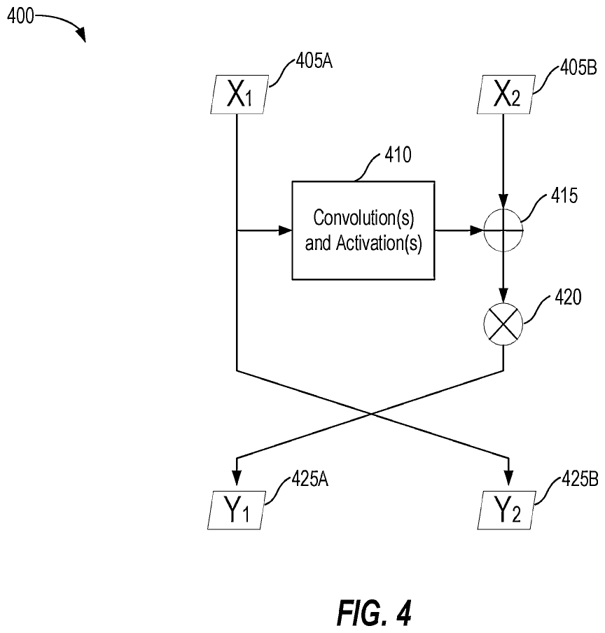

In the illustrated aspect, the invertible layer 110 is referred to as “invertible” to indicate that the input data to layer 110 (e.g., the input tensor 105) can be recreated or reconstructed based on the output data from layer 110 (e.g., based on the intermediate tensor 115). That is, while conventional training systems using non-invertible layers generally store the input tensor or other data (such as the activation data or pre-activation data in the layer) for use in backpropagation, the input tensor 105 can be reconstructed during the backwards pass, and thus, the input tensor data need not be stored. One example of an invertible layer 110 is described in more detail below with reference to FIG. 4. In some aspects, the invertible layer 110 can generally include an operation to modify the input tensor 105 based on the parameters of the layer (e.g., a convolution operation) and/or an operation to modify the input tensor 105 using an activation function (e.g., to introduce non-linearity to the model).

As illustrated, the invertible layer 110 outputs an intermediate tensor 115. In some aspects, the intermediate tensor 115 may alternatively be referred to as an activation tensor or activation data. For example, the intermediate tensor 115 may be the result of multiplying or convolving the input tensor 105 using weights specified for the invertible layer 110, and applying an activation function. In some aspects, the intermediate tensor 115 has the same size and/or dimensionality of the input tensor 105. In conventional architectures, the intermediate tensor 115 is generally used as the output from the invertible layer 110.

As illustrated, the intermediate tensor 115 is then provided to or accessed by a tensor splitter 120, which generates a stored tensor 125 and an output tensor 130. In the illustrated example, the stored tensor 125 is referred to as “stored” to indicate that tensor 125 is stored, buffered, or otherwise maintained (e.g., in computing system memory). Similarly, the output tensor 130 is referred to as “output” to indicate that tensor 130 is output or provided to a subsequent component (e.g., to a subsequent layer of the model, or as output from the model).

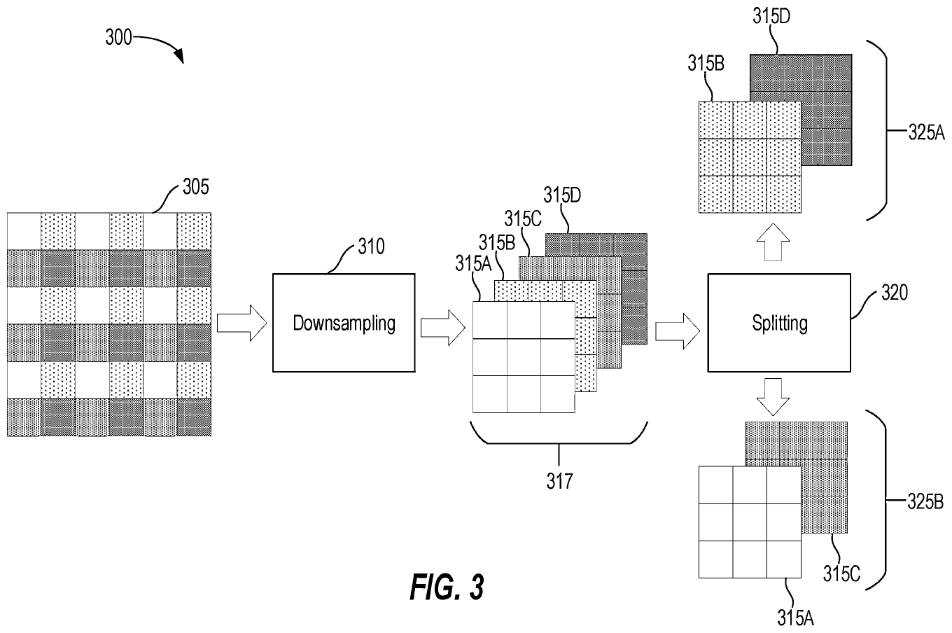

The tensor splitter 120 is generally a component (which may be implemented using hardware, software, or a combination of hardware and software) that delineates input tensors (e.g., the intermediate tensor 115) into subsets using a tensor splitting operation. In at least one aspect, the tensor splitting operation includes a downsampling operation (e.g., to reduce the spatial dimensionality of the intermediate tensor 115) and a splitting operation to delineate the downsampled tensor into two subsets. For example, the tensor splitter 120 may first reduce the spatial dimensionality of the intermediate tensor 115 (e.g., by moving some of this spatial dimensionality to the depth channel of the tensor), then generate the subsets of the tensor (also referred to as subtensors in some aspects) by dividing the downsampled tensor, such as based on the channels (e.g., where the first N channels are used as the output tensor 130, and the remaining M channels are used as the stored tensor 125). One example of a tensor splitting operation is discussed in more detail below with reference to FIG. 3.

In some aspects, the tensor splitter 120 uses a bijective function to generate the output tensor 130 and stored tensor 125. That is, given an input tensor A, the tensor splitter 120 can use the bijective function to create subtensors A₁ and A₂. As the function is bijective, A can subsequently be recreated or reconstructed based on the subtensors A₁ and A₂. In the illustrated example, therefore the intermediate tensor 115 may be reconstructed using the output tensor 130 and stored tensor 125, as discussed below in more detail with reference to FIG. 1B.

In the illustrated example, the output tensor 130 is then output to a downstream component, such as to a subsequent layer in the neural network. That is, the output tensor 130 of this layer may serve as the input tensor of a subsequent layer.

As the output tensor 130 is a subset of the intermediate tensor 115, the output tensor will generally have reduced size/dimensionality, as compared to the intermediate tensor 115. Therefore, the subsequent component (e.g., the next layer) can be smaller (e.g., having a smaller number of parameters), as compared to the invertible layer 110. For example, if the invertible layer 110 uses W parameters and the tensor splitter delineates the intermediate tensor 115 in half (e.g., where the output tensor 130 and stored tensor 125 are each half of the intermediate tensor 115), then the subsequent layer may use roughly W/2 parameters.

In this way, the overall model size is reduced, as compared to conventional invertible model architectures, as each layer that follows a tensor splitting operation can be progressively smaller than the preceding layer. Further, because the stored tensor 125 is smaller than the intermediate tensor 115, the memory footprint of the workflow 100A is reduced, as compared to conventional non-invertible models where the entire intermediate tensor 115 is stored.

Of note, the illustrated workflow 100A may be used during a forward pass of a training phase of the model. That is, during training, the system may use the tensor splitter 120 to generate and store the stored tensor 125 in order to subsequently use this tensor during the backward pass. During inferencing (e.g., after the model is trained), the system may use the tensor splitter 120 to downsample the intermediate tensor and generate the output tensor 130 for the downstream components, but the stored tensor 125 may be discarded and need not be stored. That is, the inferencing system may avoid, refrain from, or forgo storing the stored tensor 125.

As illustrated in FIG. 1B, which depicts a backward pass of training a machine learning model, a recreated output tensor 150 is accessed or received as input to tensor joiner 155. In an aspect, the recreated output tensor 150 may generally correspond to the output tensor 130 of FIG. 1A. That is, the recreated output tensor 150 may have the same values and be the same dimensionality/size as the output tensor 130. For example, as discussed in more detail below, the machine learning system may recreate or reconstruct the recreated output tensor 150 during backpropagation while training the model.

In the illustrated example, the tensor joiner 155 also receives a stored tensor 125 (e.g., generated and stored during the workflow 100A of FIG. 1A) and generates a recreated intermediate tensor 160. In the illustrated example, as discussed above, the stored tensor 125 is referred to as “stored” to indicate that this tensor was generated during a forward pass of a training process, and was stored, buffered, or otherwise maintained (e.g., in computing system memory).

The tensor joiner 155 is generally a component (which may be implemented using hardware, software, or a combination of hardware and software) that joins or aggregates input tensors (e.g., the recreated output tensor 150 and stored tensor 125), which were generated using a tensor splitting operation, into a single/original tensor (e.g., recreated intermediate tensor 160). In at least one aspect, the tensor joining operation includes use of a bijective function to rejoin the disjoint subtensors, followed by an upsampling operation (e.g., to increase the spatial dimensionality of the tensor). For example, the tensor joiner 155 may first aggregate the subtensors based on a bijective function as discussed above (e.g., to recreate the downsampled version of the intermediate tensor 115 of FIG. 1A, based on the bijective function that was used to divide this tensor), then upsample the tensor (e.g., by moving some of the channel depth to the spatial dimensions), as discussed in more detail below with reference to FIG. 3.

In the illustrated example, the recreated intermediate tensor 160 is then provided to or accessed by an invertible layer 110. In an aspect, as discussed above, the recreated intermediate tensor 160 may generally correspond to the intermediate tensor 115 of FIG. 1A. That is, the recreated intermediate tensor 160 may have the same values and be the same dimensionality/size as the intermediate tensor 115.

As discussed above, the invertible layer 110 may be an invertible neural network layer, such that the machine learning system can generate the recreated input tensor 165 (which may correspond to the input tensor 105 of FIG. 1A) based on the recreated intermediate tensor 160. The recreated input tensor 165 can then be provided to the previous or prior layer of the model (e.g., the higher layer that immediately precedes the invertible layer 110), where this tensor can be used to refine the parameters of that prior/higher layer (in conjunction with another stored tensor, in some aspects). That is, the recreated input tensor 165 may serve as the recreated output tensor of a prior/higher layer.

In the illustrated workflow 100B, the machine learning system can use the recreated intermediate tensor 160 to refine the parameters of the invertible layer 110. For example, the system may use the recreated intermediate tensor to compute gradients that can then be used to update the parameters (e.g., weights) of the invertible layer 110. In this way, the invertible layer 110 (and the overall model itself) iteratively learns to generate more accurate predictions or inferences for runtime.

Although the workflows 100A and 100B depict processing of a single tensor (e.g., corresponding to a single training sample during stochastic gradient descent), in aspects, the machine learning system may additionally or alternatively use batches of training samples to refine the model (e.g., using batch gradient descent).

As discussed above, by using the stored tensor 125 and tensor joiner 155, the overall model size is reduced, as compared to conventional invertible model architectures, as each layer that follows a tensor splitting operation can be progressively smaller than the preceding layer. Further, because the stored tensor 125 is smaller than the intermediate tensor 115, the memory footprint of the workflow 100B is reduced, as compared to conventional non-invertible models where the entire intermediate tensor 115 is stored.

Of note, the illustrated workflow 100B may be used during a backward pass of a training phase of the model. That is, during training, the system may use the tensor joiner 155 to reconstruct the recreated intermediate tensor 160 in order to subsequently use this tensor to refine the parameters of the invertible layer 110. During inferencing (e.g., after the model is trained), the system may not perform any such backward pass.

### Example Architecture for Efficient Invertible Machine Learning Model Training

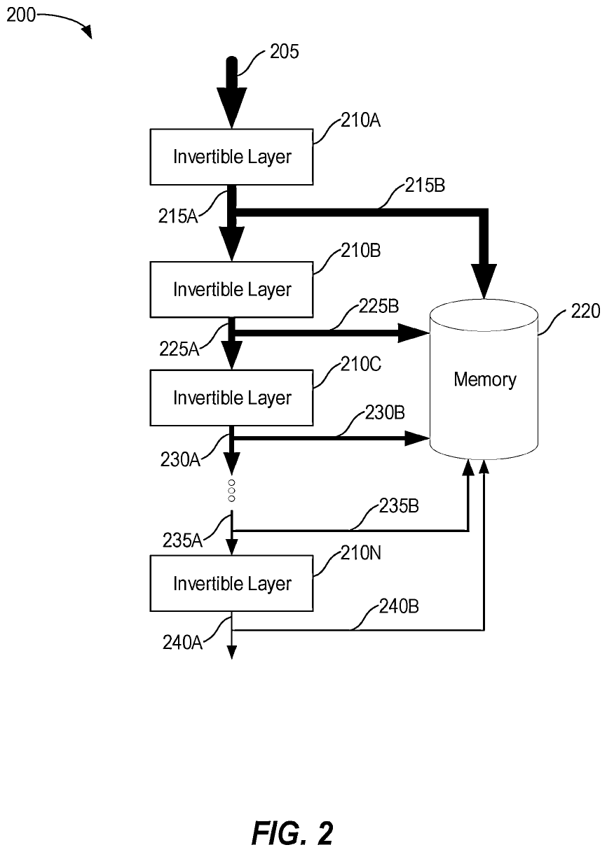

FIG. 2 depicts an example architecture 200 for efficient invertible machine learning model training. In the illustrated architecture 200, a sequence of invertible layers 210, which may correspond to all or a portion of a machine learning model (e.g., a neural network) are depicted. In at least one aspect. Each invertible layer 210 corresponds to or performs the operations of an invertible layer 110 and tensor splitter 120, each of FIG. 1A. In at least one aspect, the architecture 200 is used by a computing system, such as a machine learning system, that performs training of machine learning models (e.g., to train the sequence of invertible layers 210).

In the illustrated example, as depicted by arrow 205, a first data tensor is received for processing by a first invertible layer 210A. Although the illustrated architecture 200 depicts the invertible layer 210A as the first layer in the network, in some aspects, one or more other layers (e.g., pooling layers, normalization layers, and/or convolution layers) may be used prior to the invertible layer 210A, depending on the particular implementation. In at least one aspect, the data represented by arrow 205 corresponds to the input tensor 105 of FIG. 1A.

As indicated by the width/weight of the arrows 215A and 215B (collectively, arrows 215), the individual outputs of the invertible layer 210A is generally smaller than the input data represented by arrow 205 (e.g., because the individual outputs each have fewer elements and/or reduced dimensionality than the original input). That is, as discussed above, the data represented by arrow 215A (which is provided to the invertible layer 210B) and the data represented by arrow 215B (which is provided to a memory 220) may each be smaller than the data represented by arrow 205. In at least one aspect, the data represented by arrow 215A corresponds to the output tensor 130 of FIG. 1A, while the data represented by arrow 215B corresponds to the stored tensor 125 of FIG. 1A. In some aspects, the individual outputs of the invertible layer 210A may collectively be the same size (e.g., contain the same number of elements) as the input to the invertible layer 210A).

In some aspects, as discussed above, the data represented by arrow 215A and the data represented by arrow 215B may collectively reflect the entirety of the data represented by arrow 205. For example, as discussed above, the subtensors represented by arrows 215A and 215B may be created using a bijective function that allows the original output tensor to be recreated, which can then be used to recover the original tensor represented by arrow 205.

In the illustrated architecture 200, one of these subtensors (output by the invertible layer 210A and represented by arrow 215B) is stored in the memory 220. The memory 220 is generally representative of any data storage component, including random access memory (RAM), tightly coupled memory, storage (e.g., on a hard drive), and the like. As discussed above, this stored data may subsequently be used during the backward pass in order to refine or update parameters of the invertible layer 210A.

As illustrated by arrow 215A, the other subtensor is then accessed and processed by an invertible layer 210B. In a similar manner to the invertible layer 210A, the invertible layer 210B may generate two subtensors (represented by arrows 225A and 225B), each of which are smaller than the input tensor represented by arrow 215A. One of these subtensors is then stored in memory 220 (represented by arrow 225B) while the other is provided to invertible layer 210C (represented by arrow 225A).

The subtensor represented by arrow 225A is then accessed and processed by an invertible layer 210C. In a similar manner to the above discussion, the invertible layer 210C may generate two subtensors (represented by arrows 230A and 230B), each of which are smaller than the input tensor represented by arrow 225A. One of these subtensors is then stored in memory 220 (represented by arrow 230B) while the other is provided to a subsequent layer (represented by arrow 230A).

As indicated by the ellipsis, there may be any number of invertible layers in the model architecture. In the illustrated example, data represented by arrow 235A, which may be output by another invertible layer (not depicted), is then provided to invertible layer 210N (while data represented by arrow 235B is stored in memory 220). The invertible layer 210N similarly processes the output data (indicated by arrow 235A) and outputs two subtensors: one via arrow 240A and one via arrow 240B. Although the illustrated example suggests that the invertible layer 210N is the final layer of the machine learning model that includes the invertible layers 210, in some aspects, one or more further layers may be included, such as additional convolution, batch normalizations, activations, fully connected layers, and the like.

As depicted by the increasingly narrower arrows after each invertible layer 210, the amount of data (e.g., the number of elements in each tensor) being processed and/or stored at each layer of the model generally decreases, as compared to the prior layer. For example, suppose the data represented by arrow 205 has dimensionality B×C×H×W (where B is the batch size, C is the channel depth, and H and W are spatial dimensions such as height and width, respectively). Suppose further that each invertible layer 210 is configured to store half of its output and provide the other half to the subsequent layer.

In such an implementation, the data tensors represented by arrows 215A and 215B will each have dimensionality

$$B \times 2 C \times \frac{H}{2} \times \frac{W}{2} ,$$

the data tensors represented by arrows 225A and 225B will each have dimensionality

$$B \times 4 C \times \frac{H}{4} \times \frac{W}{4} ,$$

the data tensors represented by arrows 230A and 230B will each have dimensionality

$$B \times 8 C \times \frac{H}{8} \times \frac{W}{8} ,$$

and so on. FIG. 3, described in more detail below, depicts one such technique where channel depth is increased while spatial dimensionality (e.g., H and W) are decreased at each step.

In this way, each invertible layer 210 processes less data (e.g., fewer elements in each tensor) than the layer before (e.g., half the amount of data/number of elements). Further, the total data stored in memory 220 is reduced, as compared to conventional solutions. For example, continuing the above example, the total data that is stored in memory 220 is

$$( B \times 2 C \times \frac{H}{2} \times \frac{W}{2} ) + ( B \times 4 C \times \frac{H}{4} \times \frac{W}{4} ) + … + ( B \times {2}^{k - 1} C \times \frac{H}{{2}^{k - 1}} \times \frac{W}{{2}^{k - 1}} ) + ( B \times {2}^{k} C \times \frac{H}{{2}^{k}} \times \frac{W}{{2}^{k}} ) = B \times C \times H \times W ,$$

where k is the number of invertible layers 210 used. That is, the total memory called for is equivalent to the size of the tensor represented by arrow 205.

Although not included in the illustrated example for conceptual clarity, in some aspects, for any non-invertible layers of the model, the system may store the entirety of the input tensor, output tensor, and/or activations for that layer. Similarly, for other fully invertible layers (such as fully connected layers), the system may refrain from storing any generated output for that layer.

In the above-discussed example, each invertible layer delineates the output into two equal halves. In some aspects, however, the system need not use equal divisions. For example, each layer may provide ¾ of its output tensor to the subsequent layer, storing the other ¼. Similarly, each layer may provide ¼ of its output tensor to the subsequent layer, storing the other ¾. In some aspects, adjusting the amount of data stored at each layer may be a configurable hyperparameter (where each layer may use an independently configurable/different percentage as compared to each other layer). Generally, providing larger data tensors to the subsequent layer (e.g., where only ¼ is stored) may reduce the memory footprint of training the model, with the potential to reduce model accuracy somewhat. Conversely, storing larger tensors (e.g., where ¾ of the data is stored in memory 220) may demand a larger memory footprint, but may increase model accuracy somewhat.

### Example Workflow for Tensor Splitting to Provide Efficient Invertible Machine Learning

FIG. 3 depicts an example workflow 300 for tensor splitting to provide efficient invertible machine learning. In some aspects, the workflow 300 provides additional detail for the operations of the tensor splitter 120 of FIG. 1A. In at least one aspect, the workflow 300 is used by a computing system, such as a machine learning system, that performs training of machine learning models.

In the illustrated workflow 300, a tensor 305 (which may correspond to the intermediate tensor 115 of FIG. 1A) is first processed by a downsampling block 310 (which may generally be implemented using hardware, software, or a combination of hardware and software). As illustrated, the tensor 305 has dimensionality of 1× 6× 6. That is, the tensor 305 has a channel depth of 1 (e.g., a single channel), a height of 6, and a width of 6. The illustrated tensor 305 is merely one example for conceptual clarity, and the size/dimensionality of the tensors processed using the workflow 300 may vary depending on the particular implementation. For example, the tensor 305 may have a larger channel depth (e.g., more than one channel), larger spatial dimensions, a different height size than width size, and the like.

In the illustrated example, the downsampling block 310 generates a tensor 317 having a reduced spatial dimensionality and increased channel dimensionality. Specifically, while the tensor 305 includes 36 data elements arranged in a single channel, the tensor 317 includes 36 data elements arranged in four channels (each with nine elements): channel 315A, channel 315B, channel 315C, and channel 315D (collectively, channels 315). Although the actual size of the tensor is unchanged (e.g., both the tensor 305 and tensor 317 include the same number of data elements), the dimensionality differs, and the tensor 317 may be referred to as “downsampled” to reflect the reduced spatial dimensionality. By increasing the channel depth accordingly, the downsampling block 310 can maintain all of the data in the tensor 305 (e.g., the downsampling operation does not reduce or eliminate information in the tensor 305; this operation merely rearranges this information).

Although the illustrated example depicts decreasing the spatial dimensionality by a factor of two and quadrupling the channel depth, in aspects, the specific dimensionality of the downsampled tensor 317 may vary depending on the particular implementation. Additionally, the particular arrangement of data elements in the tensor 117 may vary, depending on the particular implementation. In at least one aspect, the downsampling operation used by the downsampling block 310 is bijective, in that the tensor 317 can be deterministically rearranged to form the tensor 305. This inverse operation (to recreate the tensor 305) may be used during the backward pass of the training phase (e.g., by the tensor joiner 155 of FIG. 1B).

In the illustrated workflow 300, the downsampled tensor 317 is then provided to a splitting block 320 (which may generally be implemented using hardware, software, or a combination of hardware and software). In the illustrated example, the splitting block 320 applies one or more functions, operations, or transformations to generate a tensor 325A and a tensor 325B (collectively, tensors 325 and/or subtensors). In at least one aspect, the tensors 325A and 325B correspond to the stored tensor 125 and output tensor 130 of FIG. 1A (where one of the tensors 325 is stored, and the other tensor 325 is output to a subsequent channel of the network).

In the illustrated example, the tensor 325A includes channels 315B and 315D from the tensor 317, while the tensor 325B includes channels 315A and 315C. That is, in the illustrated example, the splitting block 320 can generate the first tensor 325A to include one half of the channels 315 in the tensor 317, and the other tensor 325B to include the other half of the channels 315 in the tensor 317. In the illustrated example, non-adjacent channels 315 are included in each tensor 325. That is, channels 315B and 315D, which are non-adjacent in the tensor 317, are included as adjacent channels in the tensor 325A, and channels 315A and 315C, which are non-adjacent in the tensor 317, are included as adjacent channels in the tensor 325B. However, the particular distribution and arrangement of channels 315 among the tensors 325 may vary depending on the particular implementation.

Although the illustrated example depicts dividing the tensor 317 into separate tensors 325 based on channels 315, in aspects, the particular operation used to delineate the tensors 325 may vary depending on the particular implementation. For example, the splitting block 320 may use one or more of the data elements each channel 315 to form the tensor 325A, and the remaining data elements from each channel 315 to form the tensor 325B. In aspects, the splitting function used by the splitting block 320 is bijective, in that the tensors 325A and 325B can be deterministically combined and/or rearranged to form the tensor 317. This inverse operation (to recreate the tensor 317) may be used during the backward pass of the training phase (e.g., by the tensor joiner 155 of FIG. 1B).

In the illustrated example, the tensors 325 are of equal size/dimensionality. Specifically, the tensors 325 each include 18 elements arranged in two channels 315, each with 9 elements. In this way, each tensor 325 is smaller (e.g., half the size) of the tensor 317. Although an equal distribution is depicted for conceptual clarity, as discussed above, the splitting block 320 may use an unequal distribution in some aspects, depending on the particular implementation. For example, the tensor 325A may include a single channel (e.g., channel 315B), while the tensor 325B includes the remaining three channels (e.g., channels 315A, 315C, and 315D).

As discussed above, differing the size of each tensor 325 (and thereby changing how much data is stored and how much data is provided to a subsequent layer of the model) may affect various aspects of the architecture, such as the total memory footprint utilized for training, the size of the model, the final prediction accuracy of the model, and the like. In some aspects, the particular distribution of data elements between the tensors 325 (which may be referred to as the storage distribution, split distribution, and the like) may vary from layer to layer, and may be specified as a hyperparameter of the model.

In an aspect, as each step of the workflow 300 may be bijective/invertible, the process may be reversed to regenerate the tensor 305. That is, as discussed above, the tensors 325 may be combined/rearranged to form the tensor 317, which may then be upsampled/rearranged to form the tensor 305. In this way, no data is lost during the workflow 300, and the system can provide accurate and efficient model training.

### Example Architecture for an Efficient Invertible Machine Learning Model Block

FIG. 4 depicts an example architecture 400 for an efficient invertible machine learning model block. In at least one aspect, the architecture 400 corresponds to an invertible model layer, such as the invertible layer 110 of FIGS. 1A and 1B and/or the invertible layers 210 of FIG. 2. In at least one aspect, the architecture 400 is used by a computing system, such as a machine learning system, that performs training of machine learning models. In some aspects, the architecture 400 may be referred to as a Feistel layer (which can be used in some cryptographic operations), with the exception that the illustrated architecture 400 performs convolution operations for machine learning operations, rather than a round function or other operation for cryptographic operations.

In the illustrated example, the architecture 400 may be referred to as invertible to reflect that the entirety of its input (e.g., data 405A and 405B) may be deterministically identified, determined, or reconstructed based on its output (e.g., data 425A and 425B). In a conventional (non-invertible) neural network layer, input data (e.g., X) is processed using convolution to generate a tensor z that is then processed with an activation function to generate the output (e.g., Y). As z cannot be recreated based on Y, z is conventionally stored for use in backpropagation. In the illustrated example, however, data need not be stored, as discussed in more detail below.

As illustrated, the architecture 400 receives two sets of input data: data 405A and data 405B (collectively, input data 405). In some aspects, the data 405A and 405B are generated by delineating an input tensor into two subtensors. For example, an input tensor may be divided into two subtensors, which are used as data 405A and 405B. In at least one aspect, the data 405 corresponds to the input tensor 105 of FIG. 1A. That is, the input tensor 105 may be divided into two subtensors (e.g., data 405A and 405B), and provided as input to the architecture 400.

In the illustrated example, the data 405A is then provided to a block 410 that performs one or more convolutions, activation(s), and/or other operations. For example, in the case of a bottleneck layer of a neural network, the block 410 may perform a pointwise convolution, batch normalization, and activation, followed by a depthwise convolution, batch normalization, and activation, followed by another pointwise convolution and batch normalization. Generally, the block 410 uses learned parameters (e.g., weights that are learned during a training process) to generate an output, which is provided to operation 415.

In the illustrated example, the operation 415 similarly receives data 405B. In one aspect, the operation 415 is a summation operation (e.g., where the data 405B and the output of the block 410 are summed).

As illustrated, the resulting data is then provided to an operation 420. In one aspect, the operation 420 is a multiplication operation (e.g., where the output of the operation 415 is multiplied by a weight or value, which may be a learned parameter or a specified hyperparameter). In at least one aspect, the multiplication operation 420 multiplies the output of operation 415 by a constant value of 1/\sqrt{2}.

In the illustrated architecture 400, the output of this operation 420 is then provided as output data 425A from the layer. Similarly, the original input data 405A is also provided directly as output data 425B. In an aspect, the sizes of the input and output data of the architecture 400 are generally equal. That is, the size of data 405A and 405B combined may equal the size of data 425A and 425B combined.

The structure of the neural network architecture 400 is such that the original input tensors (e.g., data 405A and 405B) can be exactly reconstructed if given the output tensors (e.g., data 425A and 425B). That is, the architecture 400 is invertible. In some aspects, therefore, the architecture 400 may be used in place of any invertible layer in any model, and may also be used in place of non-invertible layers in some aspects. As an example, the depicted architecture 400 may be used to construct an invertible multilayer perceptron (MLP).

In at least one aspect, the architecture 400 can be used in conjunction with the downsampling and activation splitting operations discussed above. For example, the architecture 400 may be used to provide the functionality of the invertible layer 110 of FIG. 1A. In one such aspect, one of the output data tensors (e.g., data 425A or data 425B, collectively data 425) may be provided as input to a subsequent layer, while the other is stored (e.g., in memory). For example, the data 425A may correspond to the output tensor 130 of FIG. 1A, while the data 425B may correspond to the stored tensor 125 of FIG. 1A. In one such aspect, the subsequent layer of the model can divide the data 425A into two subtensors, which are then used as the two input data tensors to the subsequent layer.

In another aspect, the data 425 may collectively correspond to the intermediate tensor 115 of FIG. 1A. In one such aspect, the data 425 may be accessed and processed by other components (e.g., tensor splitter 120 of FIG. 1A) to generate the input to the subsequent layer.

In an aspect, using the architecture 400, the machine learning system may thereby provide improved model training with reduced memory footprint and/or model size, as compared to conventional approaches.

Example Method for Efficient Invertible Machine Learning Model Training during a Forward Pass

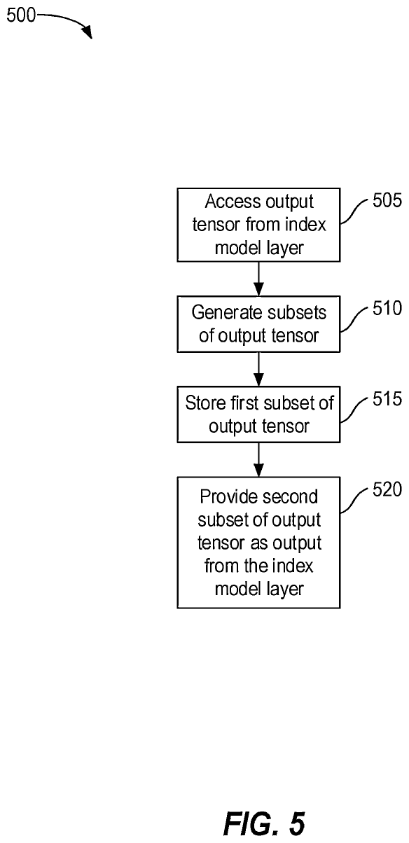

FIG. 5 is a flow diagram depicting an example method 500 for efficient invertible machine learning model training during a forward pass. In at least one aspect, the method 500 is performed by a computing system, such as a machine learning system, that performs training of machine learning models. In one aspect, the method 500 provides additional detail for the workflow 100A of FIG. 1A.

At block 505, the machine learning system accesses an output tensor from an index model layer. For example, the accessed tensor may correspond to the output of a neural network layer, such as invertible layer 110 of FIG. 1A. That is, the accessed output tensor may correspond to the intermediate tensor 115 of FIG. 1A. As used herein, accessing data can generally include a variety of actions such as receiving data, requesting data, retrieving data, and the like. Further, accessing data can generally include accessing data from a local source (e.g., a component, buffer, memory, or storage local to the machine learning system) as well as from one or more remote sources (e.g., from another component, device, or system via one or more communication links, such as a local network, the Internet, and the like).

In an aspect, the model layer is referred to as the “index” layer to allow ease of reference to particular layers in order to facilitate conceptual understanding. Generally, any layer may serve as an “index” layer with respect to the method 500. For example, an index layer may have zero or more prior or higher layers, as well as zero or more subsequent or lower layers. Generally, “prior” or “higher” layers are any layers that are processed before the index layer in the model architecture (during a forward pass), while “subsequent” or “lower” layers are any layers that are processed after the index layer in the model architecture (during the forward pass). Therefore, a given layer may be a “prior” or “higher” layer to one index layer, as well as a “subsequent” or “lower” layer to another index layer, and may itself be referred to as an “index” layer for purposes of the method 500.

For example, if the invertible layer 210B of FIG. 2 serves as the index layer, then the invertible layer 210A is the immediately prior layer and the invertible layer 210C is the immediately subsequent layer. If the invertible layer 210C of FIG. 2 is the index layer, then the invertible layer 210B is the immediately prior layer, and the invertible layer 210N is a subsequent layer. In this way, reference to a layer as the “index” layer is not related to the functionality, positioning, or operations of a layer. Instead, this terminology is used to facilitate consistent reference to other layers in the architecture.

In at least one aspect, the index model layer corresponds to the invertible layer 110 of FIG. 1A. In the illustrated example, the output tensor from the index model layer generally corresponds to the data that is output by the index layer while processing input data. For example, the output tensor may correspond to the intermediate tensor 115 of FIG. 1A, generated based on data input to the index layer (e.g., based on input tensor 105 of FIG. 1A).

At block 510, the machine learning system generates two or more subsets of the output tensor. In one aspect, as discussed above, the machine learning system may use a tensor splitting operation (e.g., performed by the tensor splitter 120 of FIG. 1A). For example, the machine learning system may use the workflow 300 of FIG. 3 to generate subtensors based on the output tensor. In at least one aspect, as discussed above, the machine learning system generates the subsets by first downsampling the output tensor (e.g., to reduce its spatial dimensionality, while potentially increasing its depth), and then using a bijective function to assign each data element in the downsampled tensor to a respective subset.

In at least one aspect, generating the subsets includes generating two subsets: one to be stored, and one to be provided as output from the index layer. In some aspects, as discussed above, the two subsets are generated with equal size/dimensionality. That is, the machine learning system may evenly partition the data elements in the output tensor into two sets. In other aspects, the subsets may be uneven. For example, one of the subsets may have ¾ of the data elements in the output tensor, while the other has the other ¼.

In some aspects, the subsets are disjoint and non-overlapping. That is, any data element in the output tensor may not be placed in both of the subsets. In some aspects, the subsets collectively cover the entire output tensor. That is, each data element in the output tensor is present in at least one of the subsets, and no elements are discarded. In at least one aspect, however, the subsets may be partially overlapping (e.g., where some of the data elements in the output tensor are included in both subsets). Generally, the subsets may be generated using any suitable operation and technique.

At block 515, the machine learning system stores one of the subsets of the output tensor for future processing. For example, the machine learning system may store the first subset in a buffer, in storage, and/or in a memory. This allows the stored subset to be subsequently retrieved for processing (e.g., during a backwards pass of the training process). In one aspect, this first subset of the output tensor may correspond to the stored tensor 125 of FIG. 1A.

At block 520, the machine learning system provides a second subset of the output tensor as output from the index model layer. That is, rather than outputting the entire output tensor (accessed at block 505), the machine learning system outputs the generated subset of the output tensor. In at least one aspect, the second subset of the output tensor corresponds to the output tensor 130 of FIG. 1A. In one aspect, the second subset of the output tensor is output as the final output of the model. In some aspects, as discussed above, the second subset is provided to a subsequent model layer. For example, the second subset may be received and processed by the immediately adjacent subsequent layer. In at least one aspect, the subsequent layer, then acting as the index layer, can perform the method 500, as discussed above, using the second subset of the output tensor as its own input tensor (at block 505).

In this way, as discussed above, the method 500 enables the machine learning system to perform efficient model training with substantially reduced memory requirements while maintaining a small model size. This improves the training of the model itself, reduces computational burden, increases the variety and type of devices that can perform training (e.g., enabling memory-constrained devices to perform training), and the like.

### Example Method for Efficient Invertible Machine Learning Model Training During a Backward Pass

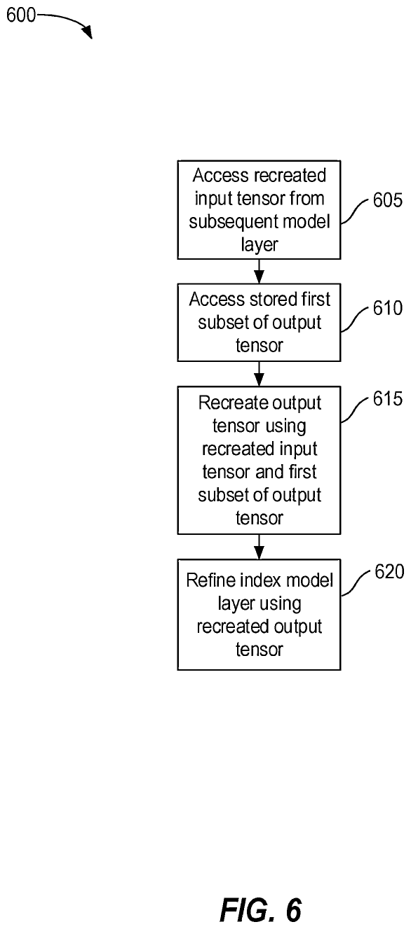

FIG. 6 is a flow diagram depicting an example method 600 for efficient invertible machine learning model training during a backward pass. In at least one aspect, the method 600 is performed by a computing system, such as a machine learning system, that performs training of machine learning models. In one aspect, the method 600 provides additional detail for the workflow 100B of FIG. 1B.

At block 605, the machine learning system accesses a recreated input tensor from subsequent model layer (e.g., subsequent to an index layer). That is, the recreated input tensor may recreate the input tensor to the subsequent layer, and may therefore alternatively be referred to as a recreated output tensor from the index layer (e.g., recreated output tensor 150 of FIG. 1B). As discussed above, the model layer may be referred to as the “index” layer to allow ease of reference to particular layers in order to facilitate conceptual understanding. For example, if the invertible layer 210B of FIG. 2 serves as the index layer, the recreated input tensor may be received from the invertible layer 210C. In the illustrated example, the recreated input tensor is referred to as an “input” tensor to reflect that this tensor was input to the subsequent/lower layer (e.g., because this tensor was output from the index layer). From the perspective of the index layer, however, the accessed tensor corresponds to an output tensor. For example, the recreated input tensor may correspond to the tensor output at block 520 of FIG. 5, and/or the recreated output tensor 150 of FIG. 1B.

In at least one aspect, the index model layer corresponds to the invertible layer 110 of FIG. 1B. In the illustrated example, the recreated tensor from the subsequent/lower layer may be recreated during a backward pass of a training phase (e.g., during backpropagation). That is, the recreated input tensor may be generated while computing gradients and updating model parameters during backpropagation. Using the chain rule, the machine learning system can thereby iterate backwards through the model layers, refining each in turn.

At block 610, the machine learning system accesses the stored first subset of the output tensor that was output by the index layer during the forward pass. For example, the machine learning system may retrieve the subset of the tensor that was stored in block 515 of FIG. 5. In at least one aspect, the stored tensor may correspond to the stored tensor 125 of FIG. 1B. As discussed above, the stored tensor subset may be maintained in any suitable location using any suitable techniques or components, such as in memory, in storage, in a buffer, and the like.

At block 615, the machine learning system recreates the output tensor of the index layer based on the recreated input tensor (received or accessed from the subsequent layer) and the stored first subset of the output tensor (which was generated and stored during the forward pass). For example, as discussed above, the machine learning system may aggregate or combine the recreated output tensor and the stored tensor (e.g., based on the bijective function used in the tensor splitting operation), and then upsample the tensor (e.g., by rearranging the elements to increase spatial dimensionality of the tensor). In at least one aspect, the recreated output tensor corresponds to the recreated intermediate tensor 160 of FIG. 1B.

At block 620, the machine learning system refines the index model layer based on the recreated output tensor. For example, as discussed above, the machine learning system may use the recreated output tensor to compute gradients used to update, refine, or otherwise modify the parameters (e.g., weights) of the index layer (e.g., of the invertible layer 110 of FIG. 1B). In some aspects, in doing so, the machine learning system similarly generates a recreated input tensor corresponding to the tensor that was received and processed by the index layer during the forward pass. This recreated input tensor can then be used by the prior model layer, acting as the new index layer, when the machine learning system performs the method 600 for the prior layer.

In this way, as discussed above, the method 600 enables the machine learning system to perform efficient model training with substantially reduced memory requirements while maintaining a small model size. This improves the training of the model itself, reduces computational burden, increases the variety and type of devices that can perform training (e.g., enabling memory-constrained devices to perform training), and the like.

### Example Method for Efficient Machine Learning

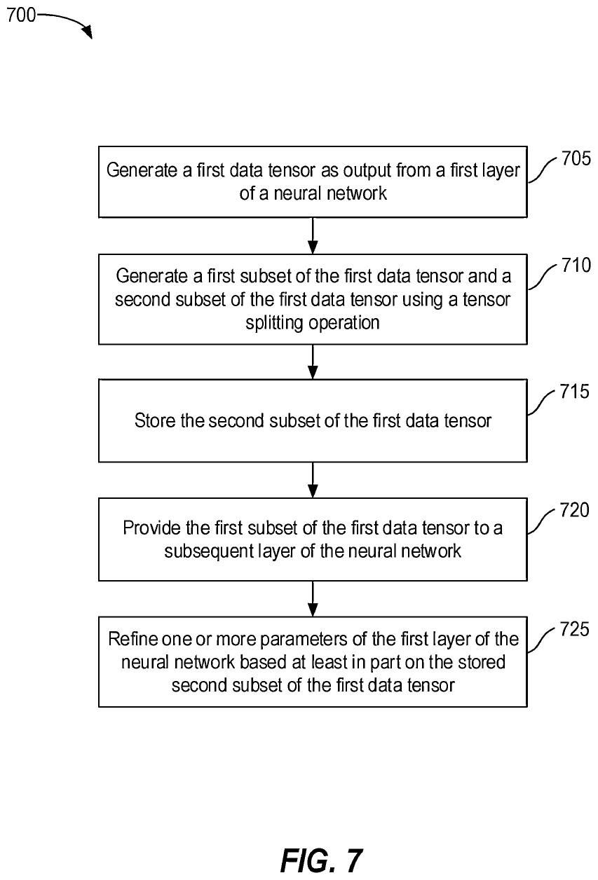

FIG. 7 is a flow diagram depicting an example method 700 for efficient machine learning. In at least one aspect, the method 700 is performed by a computing system, such as a machine learning system, that performs training of machine learning models.

At block 705, a first data tensor is generated as output from a first layer of a neural network.

At block 710, a first subset of the first data tensor and a second subset of the first data tensor are generated using a tensor splitting operation.

At block 715, the second subset of the first data tensor is stored.

At block 720, the first subset of the first data tensor is provided to a subsequent layer of the neural network.

At block 725, one or more parameters of the first layer of the neural network are refined based at least in part on the stored second subset of the first data tensor.

In some aspects, the tensor splitting operation comprises: a downsampling operation to generate a first intermediate data tensor having a reduced spatial dimensionality, as compared to the first data tensor, and an increased channel depth, as compared to the first data tensor; and a bijective function to delineate the first intermediate data tensor into the first and second subsets of the first data tensor.

In some aspects, the first subset of the first data tensor corresponds to a first set of channels from the first intermediate tensor, the second subset of the first data tensor corresponds to a second set of channels from the first intermediate tensor, and the first and second sets of channels are non-overlapping.

In some aspects, the first data tensor has dimensionality B×C×H×W, wherein B is a batch size, C is a channel depth, and H and W are spatial dimensions, and the first intermediate data tensor has dimensionality

$$B \times 4 C \times \frac{H}{2} \times \frac{W}{2} .$$

In some aspects, the first and second subsets of the first data tensor each have dimensionality

$$B \times 2 C \times \frac{H}{2} \times \frac{W}{2} .$$

In some aspects, the first subset of the first data tensor has dimensionality

$$B \times 1 \times \frac{H}{2} \times \frac{W}{2} ,$$

and the second subset of the first data tensor has dimensionality

$$B \times ( C - 1 ) \times \frac{H}{2} \times \frac{W}{2} .$$

In some aspects, refining the one or more parameters of the first layer of the neural network comprises: recreating the first subset of the first data tensor using backpropagation through the subsequent layer of the neural network; generating a recreated first data tensor by combining the recreated first subset of the first data tensor and the stored second subset of the first data tensor; and refining the one or more parameters of the first layer using backpropagation of the recreated first data tensor.

In some aspects, the first layer of the neural network performs an invertible operation.

In some aspects, the first layer of the neural network generates the first data tensor based on a first input data tensor and a second input data tensor, the first data tensor comprises the first input data tensor and a third data tensor, and the third data tensor data tensor comprises a non-linear combination of the first and second input data tensors (e.g., the first layer of the neural network comprises a Feistel layer that performs one or more convolution operations).

In some aspects, the method 700 further includes applying the tensor splitting operation after each layer of a plurality of layers of the neural network.

### Example Processing System

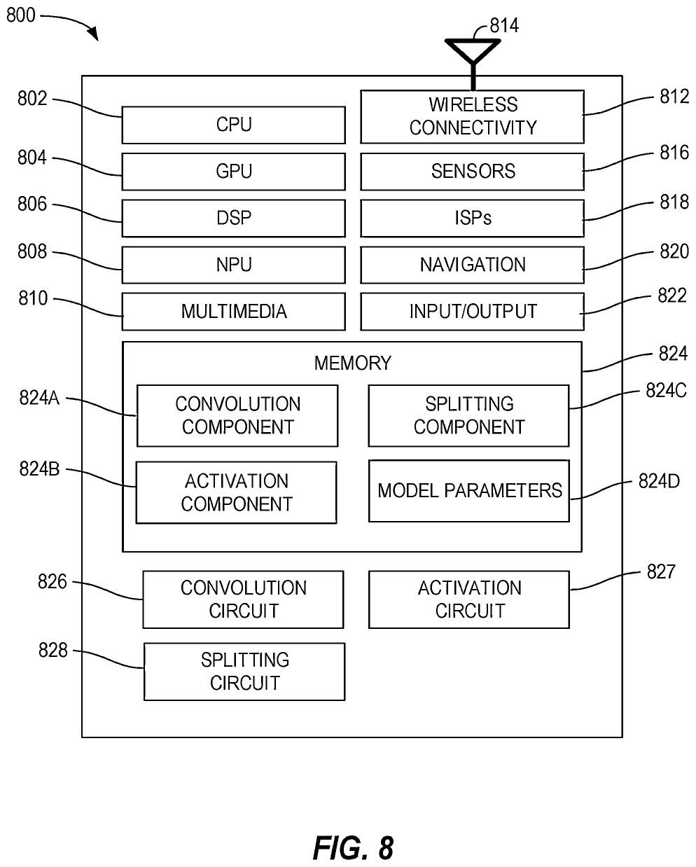

In some aspects, the workflows, techniques, and methods described with reference to FIGS. 1-7 may be implemented on one or more devices or systems. FIG. 8 depicts an example processing system 800 configured to perform various aspects of the present disclosure, including, for example, the techniques and methods described with respect to FIGS. 1-7. In one aspect, the processing system 800 may correspond to a machine learning system, such as the machine learning system discussed above with reference to FIGS. 1-7. In some aspects, the processing system 800 is an edge device or other device with limited or constrained memory, such as a smartphone, a smart watch, a laptop, a smart speaker or digital assistant, and the like. Although depicted as a single system for conceptual clarity, in at least some aspects, as discussed above, the operations described below with respect to the processing system 800 may be distributed across any number of devices.

Processing system 800 includes a central processing unit (CPU) 802, which in some examples may be a multi-core CPU. Instructions executed at the CPU 802 may be loaded, for example, from a program memory associated with the CPU 802 or may be loaded from a memory partition (e.g., memory 824).

Processing system 800 also includes additional processing components tailored to specific functions, such as a graphics processing unit (GPU) 804, a digital signal processor (DSP) 806, a neural processing unit (NPU) 808, a multimedia component 810 (e.g., a multimedia processing unit), and a wireless connectivity component 812.

An NPU, such as NPU 808, is generally a specialized circuit configured for implementing all the necessary control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPUs), neural network processor (NNP), intelligence processing unit (IPU), vision processing unit (VPU), or graph processing unit.

NPUs, such as NPU 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece through an already trained model to generate a model output (e.g., an inference).

In one implementation, NPU 808 is a part of one or more of CPU 802, GPU 804, and/or DSP 806.

In some examples, wireless connectivity component 812 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 812 is further connected to one or more antennas 814.

Processing system 800 may also include one or more sensor processing units 816 associated with any manner of sensor, one or more image signal processors (ISPs) 818 associated with any manner of image sensor, and/or a navigation component 820, which may include satellite-based positioning system components (e.g., global positioning system (GPS) or global navigation satellite system (GLONASS)) as well as inertial positioning system components.

Processing system 800 may also include one or more input and/or output devices 822, such as screens, touch-sensitive surfaces (including touch-sensitive displays), physical buttons, speakers, microphones, and the like.

In some examples, one or more of the processors of processing system 800 may be based on an advanced reduced instruction set computer (RISC) machine (ARM) or RISC-V instruction set.

Processing system 800 also includes memory 824, which is representative of one or more static and/or dynamic memories, such as a dynamic random access memory, a flash-based static memory, and the like. In this example, memory 824 includes computer-executable components, which may be executed by one or more of the aforementioned processors of processing system 800.

In particular, in this example, memory 824 includes a convolution component 824A, an activation component 824B, and a splitting component 824C. The memory 824 also includes a set of model parameters 824D. Though depicted as discrete components for conceptual clarity in FIG. 8, the illustrated components (and others not depicted) may be collectively or individually implemented in various aspects.

The model parameters 824D may generally correspond to the parameters of all or a part of one or more machine learning models. For example, the model parameters 824D may include the parameters (e.g., weights) of one or more invertible layers (such as invertible layer 110 of FIGS. 1A and 1B, invertible layers 210 of FIG. 2, and the like), parameters of the architecture 400 of FIG. 4, and the like.

Processing system 800 further comprises convolution circuit 826, activation circuit 827, and splitting circuit 828. The depicted circuits, and others not depicted, may be configured to perform various aspects of the techniques described herein.

For example, convolution component 824A and convolution circuit 826 (which may correspond to all or a part of the invertible layer 110 of FIGS. 1A and 1B, all or a part of the invertible layers 210 of FIG. 2, and/or all or part of the block 410 of FIG. 4) may be used to perform convolution operations (e.g., convolving input tensors with learned kernels or weights), as discussed above.

Activation component 824B and activation circuit 827 (which may correspond to all or a part of the invertible layer 110 of FIGS. 1A and 1B, all or a part of the invertible layers 210 of FIG. 2, and/or all or part of the block 410 of FIG. 4) may be used to process data tensors using activation functions (e.g., prior to outputting the tensor data from a model layer), as discussed above. Splitting component 824C and splitting circuit 828 (which may correspond to the tensor splitter 120 of FIG. 1A, the tensor joiner 155 of FIG. 1B, the downsampling block 310 of FIG. 3, and/or the splitting block 320 of FIG. 3) may be used to perform tensor splitting operations (e.g., downsampling tensors and using bijective functions to generate subtensors) and/or tensor joining operations (e.g., recreating original tensors based on subtensors), as discussed above.

Though depicted as separate components and circuits for clarity in FIG. 8, convolution circuit 826, activation circuit 827, and splitting circuit 828 may collectively or individually be implemented in other processing devices of processing system 800, such as within CPU 802, GPU 804, DSP 806, NPU 808, and the like.

Generally, processing system 800 and/or components thereof may be configured to perform the methods described herein.

Notably, in other aspects, aspects of processing system 800 may be omitted, such as where processing system 800 is a server computer or the like. For example, multimedia component 810, wireless connectivity component 812, sensor processing units 816, ISPs 818, and/or navigation component 820 may be omitted in other aspects. Further, aspects of processing system 800 maybe distributed between multiple devices.

### Example Clauses

Implementation examples are described in the following numbered clauses:

Clause 1: A method, comprising: generating a first data tensor as output from a first layer of a neural network; generating a first subset of the first data tensor and a second subset of the first data tensor using a tensor splitting operation; storing the second subset of the first data tensor; providing the first subset of the first data tensor to a subsequent layer of the neural network; an refining one or more parameters of the first layer of the neural network based at least in part on the stored second subset of the first data tensor.

Clause 2: A method according to Clause 1, wherein the tensor splitting operation comprises: a downsampling operation to generate a first intermediate data tensor having a reduced spatial dimensionality, as compared to the first data tensor, and an increased channel depth, as compared to the first data tensor; and a bijective function to delineate the first intermediate data tensor into the first and second subsets of the first data tensor.

Clause 3: A method according to any of Clauses 1-2, wherein: the first subset of the first data tensor corresponds to a first set of channels from the first intermediate tensor, the second subset of the first data tensor corresponds to a second set of channels from the first intermediate tensor, and the first and second sets of channels are non-overlapping.

Clause 4: A method according to any of Clauses 1-3, wherein: the first data tensor has dimensionality B×C×H×W, wherein B is a batch size, C is a channel depth, and H and W are spatial dimensions, and the first intermediate data tensor has dimensionality

$$B \times 4 C \times \frac{H}{2} \times \frac{W}{2} .$$

Clause 5: A method according to any of Clauses 1-4, wherein the first and second subsets of the first data tensor each have dimensionality

$$B \times 2 C \times \frac{H}{2} \times \frac{W}{2} .$$

Clause 6: A method according to any of Clauses 1-5, wherein: the first subset of the first data tensor has dimensionality

$$B \times 1 \times \frac{H}{2} \times \frac{W}{2} ,$$

and the subset of the first data tensor has dimensionality

$$B \times ( C - 1 ) \times \frac{H}{2} \times \frac{W}{2} .$$

Clause 7: A method according to any of Clauses 1-6, wherein refining the one or more parameters of the first layer of the neural network comprises: recreating the first subset of the first data tensor using backpropagation through the subsequent layer of the neural network; generating a recreated first data tensor by combining the recreated first subset of the first data tensor and the stored second subset of the first data tensor; and refining the one or more parameters of the first layer using backpropagation of the recreated first data tensor.

Clause 8: A method according to any of Clauses 1-7, wherein the first layer of the neural network performs an invertible operation.

Clause 9: A method according to any of Clauses 1-8, wherein the first layer of the neural network generates the first data tensor based on a first input data tensor and a second input data tensor; the first data tensor comprises the first input data tensor and a third data tensor, and the third data tensor data tensor comprises a non-linear combination of the first and second input data tensors.

Clause 10: A method according to any of Clauses 1-9, further comprising applying the tensor splitting operation after each layer of a plurality of layers of the neural network.

Clause 11: A method, comprising: accessing, at a layer of a neural network, a first input data tensor and a second input data tensor; generating, using the layer of the neural network, a first output data tensor and a second output data tensor by processing the first input data tensor and the second input data tensor, wherein: the first output data tensor is equal to the first input data tensor; the second output data tensor is generated by: applying one or more convolution operations to the first input data tensor; applying a multiplication operation to generate the second output data tensor; and the first and second input data tensors can be reconstructed based on the first and second output data tensors; and outputting the first and second output data tensors from the layer of the neural network.

Clause 12: A processing system, comprising: a memory comprising computer-executable instructions; and one or more processors configured to execute the computer-executable instructions and cause the processing system to perform a method in accordance with any of Clauses 1-11.

Clause 13: A processing system, comprising means for performing a method in accordance with any of Clauses 1-11.

Clause 14: A non-transitory computer-readable medium comprising computer-executable instructions that, when executed by one or more processors of a processing system, cause the processing system to perform a method in accordance with any of Clauses 1-11.

Clause 15: A computer program product embodied on a computer-readable storage medium comprising code for performing a method in accordance with any of Clauses 1-11.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
generating a first data tensor as output from a first layer of a neural network;
generating a first subset of the first data tensor and a second subset of the first data tensor using a tensor splitting operation;
storing the second subset of the first data tensor;
providing the first subset of the first data tensor to a subsequent layer of the neural network; and
refining one or more parameters of the first layer of the neural network based at least in part on the stored second subset of the first data tensor.

2. The computer-implemented method of claim 1, wherein the tensor splitting operation comprises:
a downsampling operation to generate a first intermediate data tensor having a reduced spatial dimensionality, as compared to the first data tensor, and an increased channel depth, as compared to the first data tensor; and
a bijective function to delineate the first intermediate data tensor into the first and second subsets of the first data tensor.

3. The computer-implemented method of claim 2, wherein:
the first subset of the first data tensor corresponds to a first set of channels from the first intermediate tensor,
the second subset of the first data tensor corresponds to a second set of channels from the first intermediate tensor, and
the first and second sets of channels are non-overlapping.

4. The computer-implemented method of claim 2, wherein:
the first data tensor has dimensionality B×C×H×W, wherein B is a batch size, C is a channel depth, and H and W are spatial dimensions, and
the first intermediate data tensor has dimensionality
$$B \times 4 C \times \frac{H}{2} \times \frac{W}{2} .$$

5. The computer-implemented method of claim 4, wherein the first and second subsets of the first data tensor each have dimensionality
$$B \times 2 C \times \frac{H}{2} \times \frac{W}{2} .$$

6. The method of claim 4, wherein:
the first subset of the first data tensor has dimensionality
$$B \times 1 \times \frac{H}{2} \times \frac{W}{2} ,$$
and
the second subset of the first data tensor has dimensionality
$$B \times ( C - 1 ) \times \frac{H}{2} \times \frac{W}{2} .$$

7. The computer-implemented method of claim 1, wherein refining the one or more parameters of the first layer of the neural network comprises:
recreating the first subset of the first data tensor using backpropagation through the subsequent layer of the neural network;
generating a recreated first data tensor by combining the recreated first subset of the first data tensor and the stored second subset of the first data tensor; and
refining the one or more parameters of the first layer using backpropagation of the recreated first data tensor.

8. The computer-implemented method of claim 1, wherein the first layer of the neural network performs an invertible operation.

9. The computer-implemented method of claim 8, wherein:
the first layer of the neural network generates the first data tensor based on a first input data tensor and a second input data tensor;
the first data tensor comprises the first input data tensor and a third data tensor, and
the third data tensor data tensor comprises a non-linear combination of the first and second input data tensors.

10. The computer-implemented method of claim 1, further comprising applying the tensor splitting operation after each layer of a plurality of layers of the neural network.

11. A processing system, comprising:
a memory comprising computer-executable instructions; and
one or more processors configured to execute the computer-executable instructions and cause the processing system to perform an operation comprising:
generating a first data tensor as output from a first layer of a neural network;
generating a first subset of the first data tensor and a second subset of the first data tensor using a tensor splitting operation;
storing the second subset of the first data tensor;
providing the first subset of the first data tensor to a subsequent layer of the neural network; and
refining one or more parameters of the first layer of the neural network based at least in part on the stored second subset of the first data tensor.

12. The processing system of claim 11, wherein the tensor splitting operation comprises:
a downsampling operation to generate a first intermediate data tensor having a reduced spatial dimensionality, as compared to the first data tensor, and an increased channel depth, as compared to the first data tensor; and
a bijective function to delineate the first intermediate data tensor into the first and second subsets of the first data tensor.

13. The processing system of claim 12, wherein:
the first subset of the first data tensor corresponds to a first set of channels from the first intermediate tensor,
the second subset of the first data tensor corresponds to a second set of channels from the first intermediate tensor, and
the first and second sets of channels are non-overlapping.

14. The processing system of claim 12, wherein:
the first data tensor has dimensionality B×C×H×W, wherein B is a batch size, C is a channel depth, and H and W are spatial dimensions, and
the first intermediate data tensor has dimensionality
$$B \times 4 C \times \frac{H}{2} \times \frac{W}{2} .$$

15. The processing system of claim 14, wherein the first and second subsets of the first data tensor each have dimensionality
$$B \times 2 C \times \frac{H}{2} \times \frac{W}{2} .$$

16. The processing system of claim 14, wherein:
the first subset of the first data tensor has dimensionality
$$B \times 1 \times \frac{H}{2} \times \frac{W}{2} ,$$
and
the second subset of the first data tensor has dimensionality
$$B \times ( C - 1 ) \times \frac{H}{2} \times \frac{W}{2} .$$

17. The processing system of claim 11, wherein refining the one or more parameters of the first layer of the neural network comprises:
recreating the first subset of the first data tensor using backpropagation through the subsequent layer of the neural network;
generating a recreated first data tensor by combining the recreated first subset of the first data tensor and the stored second subset of the first data tensor; and
refining the one or more parameters of the first layer using backpropagation of the recreated first data tensor.

18. The processing system of claim 11, wherein the first layer of the neural network performs an invertible operation.

19. The processing system of claim 18, wherein:
the first layer of the neural network generates the first data tensor based on a first input data tensor and a second input data tensor;
the first data tensor comprises the first input data tensor and a third data tensor, and
the third data tensor data tensor comprises a non-linear combination of the first and second input data tensors.

20. The processing system of claim 11, the operation further comprising applying the tensor splitting operation after each layer of a plurality of layers of the neural network.

21. A non-transitory computer-readable medium comprising computer-executable instructions that, when executed by one or more processors of a processing system, cause the processing system to perform an operation comprising:
generating a first data tensor as output from a first layer of a neural network;
generating a first subset of the first data tensor and a second subset of the first data tensor using a tensor splitting operation;
storing the second subset of the first data tensor;
providing the first subset of the first data tensor to a subsequent layer of the neural network; and
refining one or more parameters of the first layer of the neural network based at least in part on the stored second subset of the first data tensor.

22. The non-transitory computer-readable medium of claim 21, wherein the tensor splitting operation comprises:
a downsampling operation to generate a first intermediate data tensor having a reduced spatial dimensionality, as compared to the first data tensor, and an increased channel depth, as compared to the first data tensor; and
a bijective function to delineate the first intermediate data tensor into the first and second subsets of the first data tensor.

23. The non-transitory computer-readable medium of claim 22, wherein:
the first subset of the first data tensor corresponds to a first set of channels from the first intermediate tensor,
the second subset of the first data tensor corresponds to a second set of channels from the first intermediate tensor, and
the first and second sets of channels are non-overlapping.

24. The non-transitory computer-readable medium of claim 22, wherein:
the first data tensor has dimensionality B×C×H×W, wherein B is a batch size, C is a channel depth, and H and W are spatial dimensions, and
the first intermediate data tensor has dimensionality
$$B \times 4 C \times \frac{H}{2} \times \frac{W}{2} .$$

25. The non-transitory computer-readable medium of claim 24, wherein the first and second subsets of the first data tensor each have dimensionality
$$B \times 2 C \times \frac{H}{2} \times \frac{W}{2} .$$

26. The non-transitory computer-readable medium of claim 21, wherein refining the one or more parameters of the first layer of the neural network comprises:
recreating the first subset of the first data tensor using backpropagation through the subsequent layer of the neural network;
generating a recreated first data tensor by combining the recreated first subset of the first data tensor and the stored second subset of the first data tensor; and
refining the one or more parameters of the first layer using backpropagation of the recreated first data tensor.

27. The non-transitory computer-readable medium of claim 21, wherein the first layer of the neural network performs an invertible operation.

28. The non-transitory computer-readable medium of claim 27, wherein:
the first layer of the neural network generates the first data tensor based on a first input data tensor and a second input data tensor;
the first data tensor comprises the first input data tensor and a third data tensor, and
the third data tensor data tensor comprises a non-linear combination of the first and second input data tensors.

29. The non-transitory computer-readable medium of claim 21, the operation further comprising applying the tensor splitting operation after each layer of a plurality of layers of the neural network.

30. A computer-implemented method, comprising:
accessing, at a layer of a neural network, a first input data tensor and a second input data tensor;
generating, using the layer of the neural network, a first output data tensor and a second output data tensor by processing the first input data tensor and the second input data tensor, wherein:
the first output data tensor is equal to the first input data tensor;
the second output data tensor is generated by:
applying one or more convolution operations to the first input data tensor;
applying a multiplication operation to generate the second output data tensor; and
the first and second input data tensors can be reconstructed based on the first and second output data tensors; and
outputting the first and second output data tensors from the layer of the neural network.
